(19) United States
(12) Patent Application Publication
(10) Pub. No.: US 2008/0148535 A1
(43) Pub. Date: Jun. 26, 2008

(54) CLIP FOR JOINING TUBULAR MEMBERS TO SUBSTRATES

(75) Inventors: Andrew W. Santin, Newton, MA (US); Pasquale Rossi, Sarnia (CA)

Correspondence Address: HINCKLEY, ALLEN & SNYDER, LLP, 11 SOUTH MAIN STREET, SUITE 400, CONCORD, NH, 03301, US

(73) Assignee: HOPE GLOBAL, DIVISION OF NFA CORP., Cumberland, RI (US)

(21) Appl. No.: 11/615,954

(22) Filed: Dec. 23, 2006

(51) Int. Cl. F16L 3/13; A44B 17/00

(52) U.S. Cl. 24/470; 248/51; 24/464

(57) ABSTRACT

This invention provides a clip for joining tubular members that employs living hinges that are part of a unitary clip including jaws and a base spring. The jaws are joined by a center living hinge and each jaw is also joined along a surface opposite its gripping surface to a cantilevered end of the base spring by a side-mounted living hinge. When the clip jaws are in a fully open orientation, with the center hinge at a maximum distance away from the base spring, the user biases the central hinge toward the base spring. The base spring ends are thereby biased away from each other, and after the jaws rotate about their living hinges through a position of maximum spread in the base spring ends, the spring ends rebound, forcing the jaws downward toward the base spring, and into a fully closed orientation. The clip includes a base that can be an anchor that embeds in foam of an upholstery cushion, or can have an adhesive that allows it to be secured to a structure, in the case of a pipe or conduit clamp. The clip can be formed by extrusion, with the hinges optionally coextruded from a more-resilient material. The extrusion can define a strip with cut lines therein that nearly separate the individual clip segments, enabling the clip strip to be stored on a spool and paid out as needed.

### FIELD OF THE INVENTION

This invention relates to clips that secure to objects by elastic deformation of their structure, and more-particularly to biased-hinge clips.

### BACKGROUND OF THE INVENTION

Spring-loaded clips are used to join a variety of items to other structures. A commonly-used spring-loaded clip is the ordinary clothespin. This type of clip employs a wound metal spring to bias a pair of wooden or plastic jaw members together so as to apply frictional holding force to an object of clothing. While a separate spring member (constructed from a dissimilar material to that of the jaws) is common, other types of clips integrate a unitary spring into their construction.

One type of clip with a unitary (e.g. molded/formed as a single unit) clip design is the biased hinge clip. An example of a biased-hinge clip is taught in U.S. Pat. No. 3,720,979, entitled BIASED HINGES, by Krawagna. The clip is constructed using a pair of jaw members connected by a resilient hinge link that is sometimes termed a “living hinge,” in that it is a unitary part that joins the two hinged members together. Often the living hinge is defined by a narrowed region between two thicker parts that affords a degree of flexibility to the hinge section, while the attached members remain more rigid.

In the exemplary clip, the jaw members are each attached along their sides to opposing resilient hinge joints that interconnect with a semicircular spring base. The spring base allows the two jaws to rotate between a fully closed and a fully opened orientation. As the jaws open or close, the spring force bearing upon the jaws is overcome by the lever action of the jaws about the hinges. This causes the base to flex so as to absorb the hinging motion. The spring bias on the jaws forces then into either a fully opened or fully closed state. In the fully-closed state, the jaws maintain a predetermined pressure against each other so as to frictionally retain an object placed therebetween.

Such biased hinges are sometimes referred to as snap-hinges-due to the distinctive click that is heard and felt when the hinge locks or unlocks. These hinges have been employed in a variety of applications, such as clips used to hold X-ray and camera film. These clips are characterized by a pair of clamping jaws and an opposing hanging hook attached to the spring base.

In a number of industries, and particularly in the field of automotive upholstery, resilient clips are used commonly to secure upholstery to the foam cushion substrate. A seat is commonly constructed from at least three parts, (a) the underlying seat frame, which is often constructed from metal steel tubes formed into the outline of the seat, (b) a cushion that overlies the frame and is secured to the tubular frame, and (c) a n outer upholster layer or “skin” that wraps around the cushion and is secured to the frame. This skin often includes various pleats that conform to valleys molded into the cushion, providing the cushion with a more contoured and stylish look. Clips are often embedded in the foam at these valley locations during the molding process so that a bead on the upholstery seam can be subsequently snapped in place to create a characteristic pleat in the upholstered seat cushion. This system affords significantly quicker assembly and requires less skill that the earlier technique in which pleats were formed by applying metal rings between an anchor on the cushion and the upholstery. In addition the newer clip-down technique provides the installer with at least a small degree of tactile and auditory feedback when he or she has successfully secured a bead section to a clip—as evidenced by a noticeable “click.”

Nevertheless, the actual foam cushion is attached to the underlying tubular seat frame using more time consuming techniques that require proper alignment and the application of glues and adhesives to secure the foam to the frame tube. The adhesive process often forms a weak joint that is prone to detachment after the seat has been in use. Once detached, the cushion tends to dislocate, forming bulges in the upholstered seat. A technique that would allow this operation to be expedited, simplified and to provide better feedback of success is desirable.

Moreover, there are many other applications in which the ability to quickly and easily attach a base to a tubular member of a known, approximate cross sectional shape and size is desirable.

### SUMMARY OF THE INVENTION

This invention overcomes disadvantages of the prior art by providing a clip for joining tubular members that employs living hinges that are part of a unitary clip including jaws and a base spring. The jaws are joined by a center living hinge and each jaw is also joined along a surface opposite its gripping surface to a cantilevered end of the base spring by a side-mounted living hinge. When the clip jaws are in a fully open orientation, with the center hinge at a maximum distance away from the base spring, the user biases the central hinge toward the base spring. The base spring ends are thereby biased away from each other under elastic deformation, and after the jaws rotate about their living hinges through a position of maximum spread in the base spring ends, the spring ends rebound, forcing the jaws downward toward the base spring, and into a fully closed orientation. Where a member is brought into contact with the center living hinge, it causes the jaws to close around it, resulting in an automatically closing clip. Once closed, the jaws retain the member against subsequent pullout. The clip includes a base attached to the spring base that is particularly adapted for a desired purpose. Thus, the base can be an anchor that embeds in foam of an upholstery cushion. In such an implementation, the cushion is attached to a tubular seat frame using the clips to snap it in place. The base can have an adhesive that allows it to be secured to a structure, in the case of a pipe or conduit clamp. The base can support a second clip of a predetermined size and shape. The second clip can be permanently mounted or attached by a fastener that allows the orientation of the two attached clips to be varied.

In an illustrative embodiment, the base spring and the jaws can be provided with interengaging hooks that lock the structure together in the fully closed orientation. Alternatively, a hook assembly can be arranged between the opposing jaw ends so that the fully closed position biases the hook ends into engagement for permanent locking. The clip can be formed by extrusion, with the hinges optionally coextruded from a more-resilient material. The extrusion can define a strip with cut lines therein that nearly separate the individual clip segments. The remaining material therebetween (typically along adjoining bases) allows the clip segments to bend with respect to each other, thereby enabling the clip strip to be stored on a spool and paid out as needed. An automated process can be employed in which clips are paid out to a manipulator that cuts clip segments from the end of a roll, grasps them, and deposits them in a desired location, such as a foam cushion mold cavity.

The clip can include a grasping surface on its jaws that is serrated to enhance grasping friction against soft-sided members. Alternatively, the clip can include a high-friction surface that is applied or coextruded onto the jaws. This material facilitates grasping of objects with smooth surfaces and/or slightly larger/smaller/irregular shapes relative to the jaws.

### BRIEF DESCRIPTION OF THE DRAWINGS

The invention description below refers to the accompanying drawings, of which:

FIG. 1 is a perspective view of a clip for joining tubular members to substrates employing a unitary, biased hinge construction according to an illustrative embodiment;

FIG. 2 is a side cross section of the clip of FIG. 1 with clamping sections/jaws in a fully opened orientation;

FIG. 3 is a side cross section of the clip of FIG. 1 with clamping sections/jaws in a fully closed orientation;

FIG. 4 is a side cross section of the clip of FIG. 1 embedded in a foam substrate with clamping sections/jaws opened to receive the depicted tubular member;

FIG. 5 is a side cross section of the clamp in FIG. 4 with clamping sections/jaws closed and securing the tubular member;

FIG. 6 is a perspective view of a strip of clips formed in an extrusion process and including a representation of an optional dissimilar material provided in the hinge regions to afford greater resilience to the structure;

FIG. 7 is a simplified perspective view of a mechanism for applying clamps from a continuous strip of joined clamps to a mold cavity is a perspective view of a strip of clips formed in an extrusion process and including a representation of an optional dissimilar material provided in the hinge regions to afford greater resilience to the structure;

FIG. 8 is a side cross section of the clip with the clamping sections/jaws in an opened state, including a locking mechanism for securing the sections/jaws in a closed state according to an alternate embodiment;

FIG. 9 is a side cross section of the clip of FIG. 8 showing the clamping sections/jaws in a closed state with the locking mechanism engaged;

FIG. 10 is a side cross section of a clip showing the clamping sections/jaws being variable in their length of extension according to an alternate embodiment;

FIG. 11 is a side cross section of a clip in which the clamping sections/jaws include interlocking ends according to an alternate embodiment;

FIG. 12A is a side cross section of a clip having a serrated surface adapted for gripping a soft and/or pliable surface applied to the outer wall of a tubular member according to an alternate embodiment;

FIG. 12B is a side cross section of a clip having a high friction coating attached to its inner jaw surfaces according to an alternate embodiment;

FIG. 13 is a perspective view of a clip adapted to secure a tubular member, such as a pipe or conduit and including an adhesive backing for securing the clip base to a surface according to an alternate embodiment;

FIG. 14 is a perspective view of a clip having a base adapted to be secured to a surface using fasteners;

FIG. 15 is a double-ended clip for joining two tubular members of various sized together;

FIG. 15A is a fragmentary side view of a pair of clip bases in accordance with various embodiments of this invention joined in a rotatable configuration by a fastener; and

FIG. 16 is a partially exposed side view of a series of interconnected, mostly separated clips wrapped onto a spool or roll for subsequent pay-out to a feeding device or other utilization device.

### DETAILED DESCRIPTION

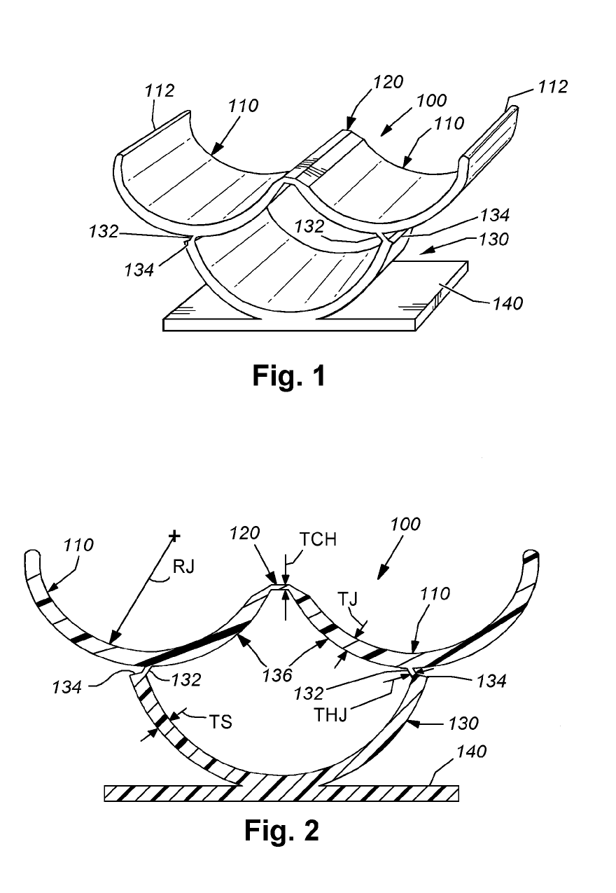

FIG. 1 details a clip 100 for securing tubular members according to an illustrative embodiment. As used herein, the term tubular will refer to a hollow or solid structure of any acceptable cross sectional shape and/or size. The clip 100 is shown in a fully open orientation with a pair of clamping sections or jaws 110 spread apart so that their ends 112 are at a maximum spacing from each other. Referring also to the side cross section of FIG. 2, the jaws 110 in this embodiment define a pair of semicircles with an inner radius RJ. The semicircular shape and particular radius RJ are sized and arranged to conform to the outer dimension of a particular cylindrical-shaped member. As will be discussed further below, the size and shape of the jaws can be varied to accommodate members having differing sizes/shapes (for example ovular or polygonal shapes.

The jaws are joined along a longitudinal centerline at a hinge 120. The hinge 120 defines a living hinge with a thinned region of the overall jaw structure, and is formed unitarily with the jaws 110. The hinge may be constructed from a dissimilar material (a more resilient plastic, for example) relative to the jaw material (a more rigid plastic, for example). Flexibility is further provided by defining the hinge thickness TCH to be narrower that the jaw thickness TJ. For example, where the jaw thickness is between approximately 2 and 4 millimeters, the hinge thickness is 0.3-0.7 millimeters. These dimensions are exemplary and adapted toward a clip with a jaw radius RJ of between 1 and 5 centimeters. These relationships are highly variable, depending in part upon the materials employed in the clip and its hinges.

The jaws 110 are each joined along their respective opposing outer surface to a semicircular spring base 130. Each hinge joint 132 is a narrowed region that joins the opposing, cantilevered ends 134 of the spring base 130 to locations along the outer surface 136 of each jaw 110. The thickness of the hinge joint 132 can have a thickness THJ similar to that of the center hinge 120 so as to define a flexible, living hinge between the spring base 130 and the respective jaws 110. In this embodiment, the spring base defines a semicircular cross sectional shape as shown. This shape corresponds approximately to the shape of the jar outer surfaces in the region between the hinges 132. The thickness TS of the spring is highly variable. In the above example, the thickness is between approximately 2 and 4 millimeters. The thickness of both the jaws 110 and the spring base 130 can be constant or variable along their respective surfaces to achieve desired effects.

The spring base 130 is joined to a base plate 140 at the bottom of the spring base 130. The base plate 140 herein is shown as a rectangle. As described below, the base plate can be any acceptable shape.

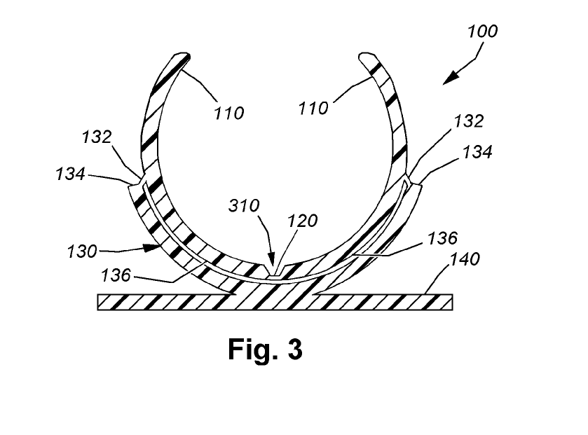

As shown now in FIG. 3, the clip 100 has been placed in a closed orientation. The two jaws define a predetermined, continuous semicircular shape suitable for gripping a circular object. The center hinge 120 resides at the bottom of a groove 310 that defines the thinned dimension of the hinge relative to the surrounding jaws 110. As described above, the outer surface of each jaw conforms relatively closely to the shape of the spring base 130 in the closed orientation.

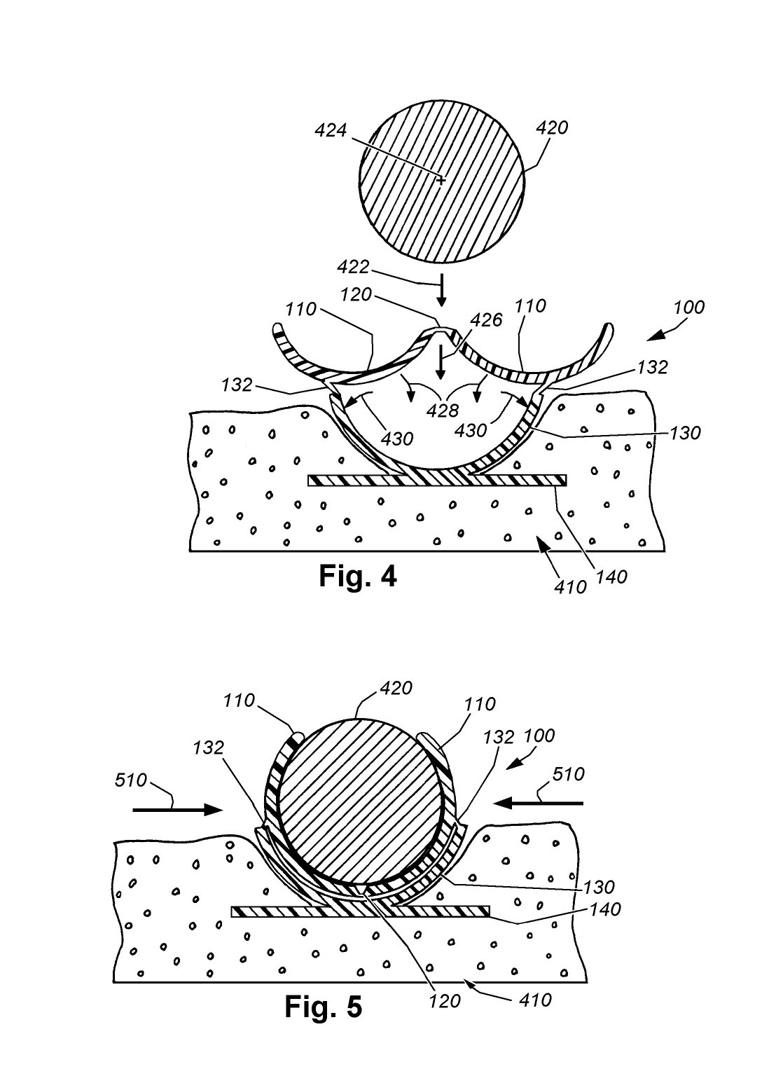

Referring now to FIGS. 4 and 5, the operation of the clip 100 in an exemplary implementation is shown in further detail. In this implementation, the clip base plate 140 is embedded in foam 410 used, for example, to construct an automotive seat cushion. The material of the clip and/or base plate is chosen so that it provides good adhesive properties to the foam (urethane foam, for example). So typical materials are glass-filled nylon, thermoplastic elastomer (TPE), including, but not limited to, polyethylene, polypropylene, polystyrene, various composites, and/or polycarbonate. The use and formation of these materials using processes such as extrusion is described further below.

In FIG. 4, a tubular member 420 having an appropriate outer dimension (neither too large nor too small for the jaw size) is directed toward (arrow 422) the clip 100 (or the clip 100 is directed toward the member 420). In particular, the member 420 is aligned so that its longitudinal axis 424 is aligned parallel with the extension axis of the center hinge 420. When the member contacts the hinge, it biases the hinge 120 downwardly (arrow 426). This downward motion causes the relatively rigid jaw surfaces to rotate (arrows 428 about the hinges 132). This rotation generates outwardly directed forces (arrows 430) upon the spring base, causing it to flex, as a leaf-spring. Note that some flexure also occurs within the jaws in many implementations. As the leaf spring flexes, thereby allowing the jaws to rotate inward as shown, the tubular member eventually bottoms-out the jaws as shown in FIG. 5. In this fully closed orientation, the tubular member is fully captured by the jaws as shown. The bottoming-out of the clip jaws 110 against the spring base 130 is often accompanied with an audible and tactile “click.” This aids the user in ensuring that positive seating of the clip to the member 420. This can be highly beneficial in a number of environments—particularly a manufacturing environment in which the click can act as a mechanism quality control feedback. Moreover, this clip essentially provides an automatic-closure mechanism that is operated by biasing the member into engagement with the opened clip.

In the fully closed orientation of FIG. 5, the spring base 510 biases the jaws 110 generally toward each other, thereby providing resistance force against reopening the jaws. The tubular member 420 must overcome this force to pull-out of the clip. As will be described below the length of extension of the jaws around the member may enhance the resistance of the clip to pullout of the member. Likewise, various supplemental locking mechanisms can be employed to further resist opening of the clip once it is closed. These mechanisms are also described further below.

Before describing various alternate embodiments of the clip and methods of manufacture, the foregoing description may be summarized as follows: The clip employs living hinges that are part of a unitary clip structure including jaws and a base spring. The jaws are joined by a center living hinge, and each jaw is also joined along a surface opposite its gripping surface to a cantilevered end of the base spring by a side-mounted living hinge. When the clip jaws are in a fully open orientation, with the center hinge at a maximum distance away from the base spring, the user biases the central hinge toward the base spring. The base spring ends are thereby biased away from each other under elastic deformation, and after the jaws rotate about their living hinges through a position of maximum spread in the base spring ends, the spring ends rebound, forcing the jaws downward toward the base spring, and into a fully closed orientation. Where a member is brought into contact with the center living hinge, it causes the jaws to close around it, resulting in an automatically closing clip.

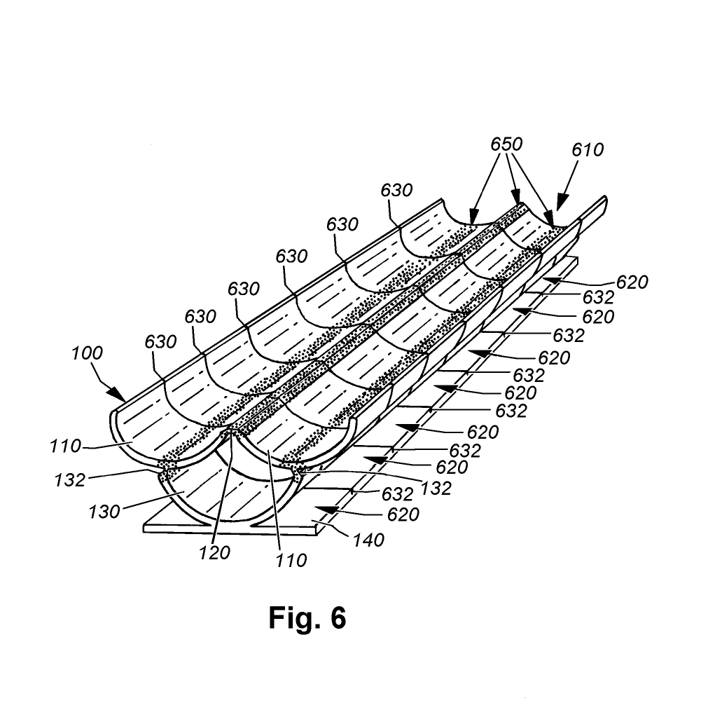

The clip of this invention can be constructed in a variety of manners, using a variety of commercially available materials. Referring to FIG. 6, the clip 100 according to an illustrative embodiment can be formed as part of a continuous strip 610 of interconnected segments 620. Each of the segments in this embodiment has been partially separated from adjacent segments along transverse cut lines 630. In this example, the transverse cut lines 630 are spaced at equal intervals (2-4 centimeters in the above exemplary clip). In this embodiment, the cut lines 630 pass nearly the full height through the structure, but are stopped near the bottom of the base plate 140, providing a thin (1-2 millimeter) interconnection 632 across all (or part) of the adjoining base plates 140. This facilitates easier separation of individual clips for sue by hand or machine. It also facilitates the winding of clips onto a spool or roll, as described further below.

A strip of continuous clips can be formed using a variety of techniques including molding and casting. In an illustrative embodiment, well-known extrusion processes are employed, whereby a selected material in a formable solid or liquid state is passed under pressure through a die (or dies) having a respective cavity that matches the outline/cross section shape of the strip 610. As the strip exits the extrusion device (not shown), a blade provides the illustrative cut lines 630 at desired intervals. The blade, or another cutter, can fully cut off a strip end when a strip of desired length has been completed. As discussed above, it is often desirable to provide particular properties to the clip so as to facilitate strength, long-live, flexibility and/or adhesion to other materials (foam, for example). Often, it is desirable to provide rigidity and durability to the jaws, resilience to the hinges, flexibility to the spring base and adhesive properties to the base plate. This mix of properties within a single strip can be attained through well-known coextrusion techniques. In the depicted strip 610, the regions that contain the hinges 120 and 132 have been coextruded in more-resilient, elastic material, such as a flexible TPE—as indicated by shaded areas 650—while the surrounding unitary material is a more rugged/rigid material such as polycarbonate. It should be clear that a wide range of possible coextruded materials can be incorporated into the clip. In additions, the formation process may take advantage of certain physical properties within the chosen, coextruded material to increase fatigue life. It is know that flexing the material (for example, polyethylene, polypropylene and nylon) while warm serves to realign the polymer chains so as to provide the hinge material with the ability to withstand many more-thousands of cycles than an untreated material.

A notable advantage to the use of biased hinge/living hinge clips as shown herein is that, in an opened orientation, these clips exhibit a lower profile that a traditional clip. These clips also resist compression forces better. Hence, when installed in substrates that undergo compression forces during manufacture, the clips of this invention are more likely to escape damage.

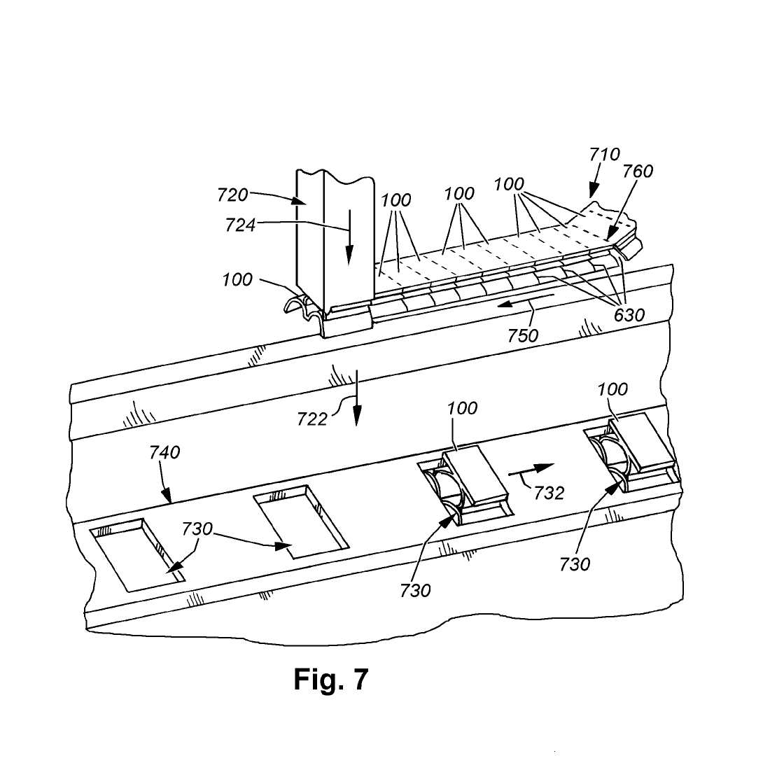

As described above, the formation of clips on a long, continuous strip facilitates the installation of clips in an automated environment. FIG. 7 details an exemplary strip 710 of mostly separated clips 100 as they are deposited (arrow 722) in turn by a manipulator 720 into wells 730 formed in a mold cavity 740. The manipulator can provide a part-picking-and-placing function of known design with a cutting function. In this manner the manipulator's downward movement (arrow 724) separates the downstream-most clip from the strip 710, and it is thereafter grasped and carried down to the waiting well 730. In this example the wells move (arrow 732) to become indexed with the manipulator 720. In alternate implementations, the manipulator may move in a variety of directions/degrees of freedom with respect to the underlying target, the target may move in a number of directions/degrees of freedom with respect to the manipulator, or both the target and manipulator may move as appropriate. As clips are cut and fed from the end of the strip 710, the strip is indexed (arrow 750) to deliver the next downstream-most clip to the manipulator for use. Because the clips 100 are nearly separated by the cut lines 630, the strip is somewhat flexible between clip segments. As shown a bend 760 has been established where one cut line is opened slightly. This flexibility can facilitate feeding and storage, as described further below.

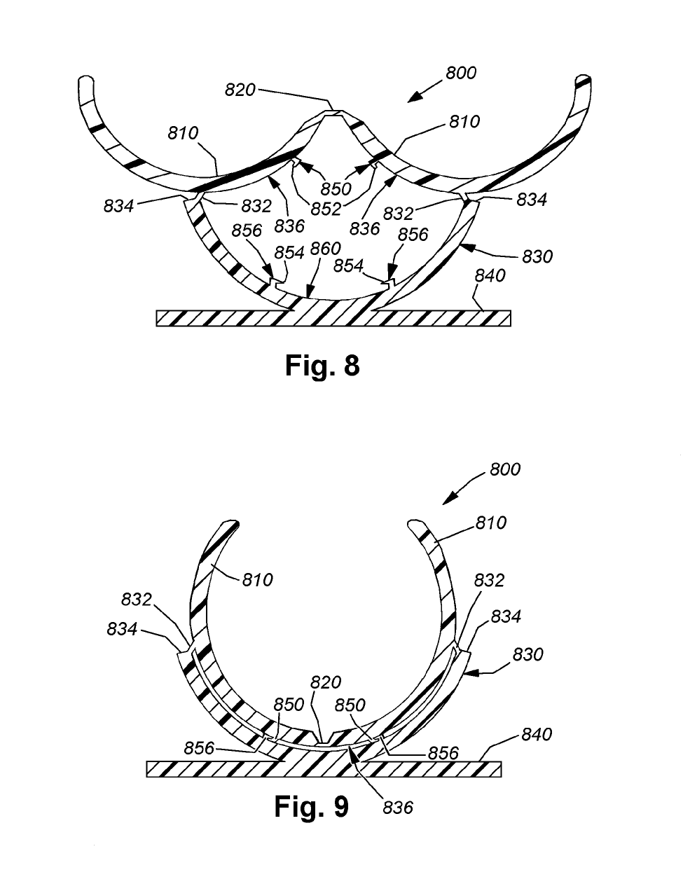

Referring to FIGS. 8 and 9, a clip 800 for joining tubular members according to an alternate embodiment is shown. The clip 810 is substantially similar or identical in characteristics to that of FIG. 1. The clip 810 includes jaws 810 that conform to a predetermined member cross sectional profile, and a center living hinge 820 that joins the jaws 810. The jaws are biased by a semicircular base sprint 830 that includes cantilevered free ends 834 having living hinges 832 that connect along the surface 836 of each respective jaw 810. The base spring 830 is attached to a base plate 840 of appropriate size and shape in this embodiment.

Notably, the external surface 836 of each jaw 810 carries a hook-like projection 850. Each projection 850 contains a protuberance 852 that is adapted to interengage an opposing protuberance 854 on a hook-like projection 856 located on the facing side 860 of the spring base 830. The projections 850, 856 are aligned so that the protuberances 852, 854 cause mutual elastic deformation of the projections as the protuberances pass by each other when the jaws 810 are biased into the fully closed orientation. This locked position is shown in FIG. 9. The opposing hook projections 850, 856, thus, provide a mechanism in which the fully closed position is permanently locked (absent special manipulation of the projections), once deployed. In the illustrative, extruded structure, the projections 850, 856 extend the full longitudinal length of each clip.

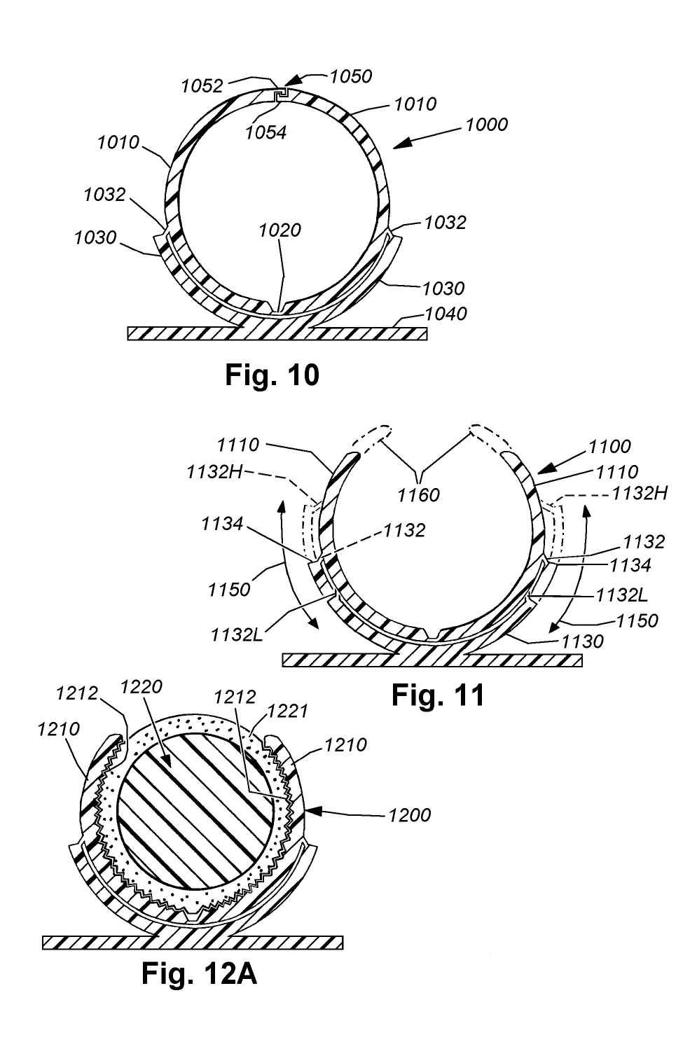

An alternate locking mechanism is shown in FIG. 10. The clip 1000 of this embodiment is constructed similarly to the clip 100 in FIG. 1. It includes opposing jaws 1010. A center living hinge 1020 joins the jaws 1010. The jaws 1010 are biased together in the depicted fully closed position. The jaws 1010 are connected to the base spring 1030 via respective living hinges 1032. The base spring is attached to an appropriately sized base plate 1040. The jaws 1010 in this embodiment extend to meet each other at the “twelve-o'clock” position 1050, in which a pair of interengaging hook projections 1054 and 1054 is provided at the opposing edges of each of the jaws. The hook projections each include corresponding protuberances that, like those of FIG. 9 override each other, and elastically deform when the jaws are biased into a fully closed position, thereby creating a permanently locked structure with substantial resistance to pull-out. For the purpose of this description, each jaw can be defined as a half-circle so that the free ends thereof meet at the above-described twelve-o'clock position 1050.

Referring now to the exemplary clip 1100 of FIG. 11, the geometry of the jaws and their interconnection with the spring base dictates the amount of force needed to move the jaws from a fully opened to a fully closed position, and, conversely, the amount of force needed to reopen the jaws. As shown in FIG. 11, the exemplary clip 1100. In general, the position of the living hinges 1132 along the jaws 1110 dictates the spring force profile applied to the jaws by the base spring 1130. The spring position can be varied between a high position (1132H), a central position (1132) and the low position (1132L). The cantilevered ends 1134 of the base spring 1130 are adjusted (arrows 1150) to conform to the desired location of the hinges 1132. Note also that extend jaw ends 1160 (shown in phantom) are illustrated. The length of the jaws can vary widely depending upon the application.

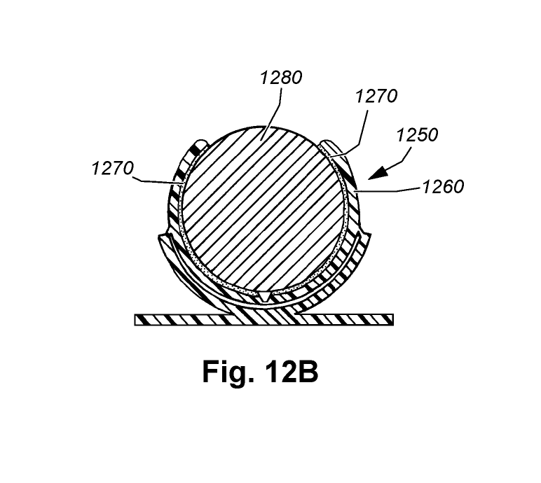

The internal surface of the clip can be textured or serrated to increase the grip relative to certain types of surfaces. FIG. 12A details a clip 1200 according to an alternate embodiment in which the jaws 1210 include serrations 1212 along the gripping surfaces. Such serrations 1212 are particularly useful in gripping a tubular member 1220 having a soft or pliable covering layer 1221. Serrations of this type can be formed in an extrusion process, since they extend generally in a longitudinal direction that corresponds with the direction of extrusion.

In FIG. 12B an alternate embodiment of a clip 1250 includes jaws 1260 having a coating 1270 along their confronting gripping surfaces. The coating provides a pliable and/or high-friction surface that better secures the member 1280 against axial/longitudinal sliding and pull-out. The coating can be formed by coextruding an appropriate polymer, such as soft TPE with the clip, or by applying a coating to the clip after it is formed. The coating can enable a slightly larger or smaller member to be firmly gripped, particularly where the coating is thicker, and deforms to conform to the shape of the member. This coating is also useful when the clip is employed to removably secure, for example, tool handles.

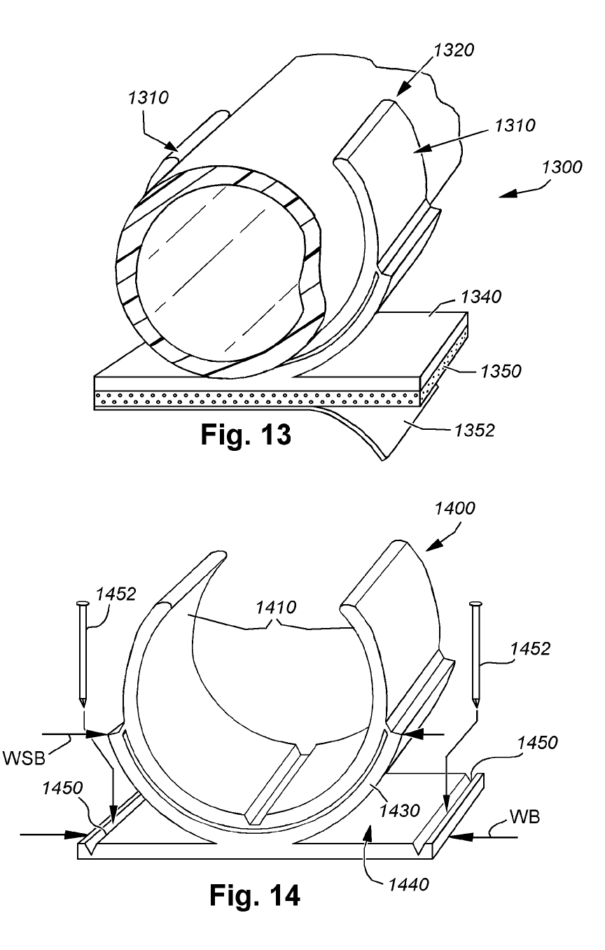

The clip base can be adapted to allow for a variety of applications other than upholstery. As shown in FIG. 13, a clip 1300 includes jaws 1310 sized and arranged to secure a pipe or conduit 1320. In this embodiment, the base 1340 includes a layer of high-stick, self-adhesive tape 1350. The adhesive surface allows this clip to be secured to a wall or other structure. The adhesive is exposed by removing a pull strip 1352 in this embodiment. A variety of alternate adhesive systems can be employed.

In FIG. 14, the clip 1400 includes a base 1440 with V-shaped grooves 1450 formed near the outer edges. The width WB of the base is chosen to place the grooves 1450 beyond the maximum width WSB of the clip jaws and 1410 spring base 1430. This provides clearance to drive nails or other fasteners (nails, screws, etc) 1452 through the grooves 1450 and into an underlying surfaces, such as wall studs, posts and drywall anchors. The grooves 1450 provide a mechanism for centering the fasteners and also for more easily passing through the base material. They can be omitted in alternate embodiments where the base is constructed from a soft material that is readily pierced without shattering. Alternately, the groove regions can be constructed from a softer, co-extruded material that accepts piercing by appropriately sized fasteners more readily.

In this embodiment, grooves 1450 that extend along the full longitudinal direction of the base 1440 are employed as these are readily formed by extrusion processes. In alternate embodiments, the base 1440 can be provided with holes or discrete wells (countersunk formations) that can be formed using alternate, post-extrusion processes, such as punching or drilling.

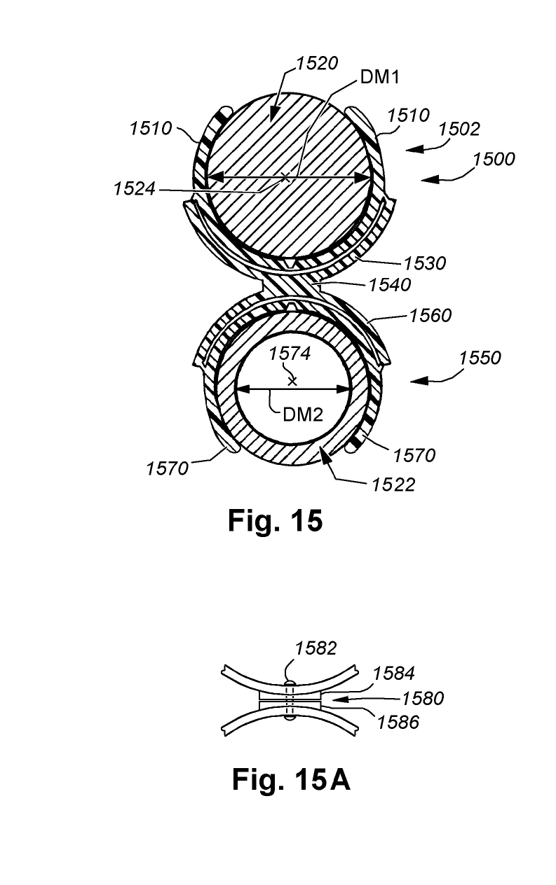

As described above, the clip base can vary widely in structure and function. As shown in FIG. 15, a clip assembly 1500 having a pair of joined clips 1502 and 1550 that face in opposing directions is shown. The clips are joined at a common base 1540 that connects the opposing spring bases 1530, 1560 that bias respective pairs of jaws 1510, 1570. The pairs of jaws 1510, 1570 are each sized to engage respectively sized members 1520, 1524. In this exemplary embodiment, the members 1520 and 1522 have respective diameters DM1 and DM2 that differ. In this example, both clips 1502 and 1550 are aligned along parallel longitudinal axes 1524 and 1574, respectively. This arrangement is readily formed by extrusion. In alternate embodiments, a pair of clips can be joined with non-parallel longitudinal axes. The clips can be joined in this manner using fasteners, adhesives, welding and the like. For example, FIG. 15A details an assembly 1580 of clip bases 1584 and 1586 that are joined in a swivel arrangement. A through-fastener 1582 rotatably secures the bases 1584, 1585 together. The fastener 1582 can be a metallic or polymer screw, rivet or other fastening mechanism. It allows one base 1584 to rotate relative to the other 1586, which is a useful element in assemblies, such as pantographs, which are used (for example) in lawn chairs, tents and the like. In alternate embodiments, the bases can include frictional, toothed (or other locking) surfaces so that tightening the fastener locks the bases in an appropriate angular relationship (e.g. the angle of one longitudinal axis to the other).

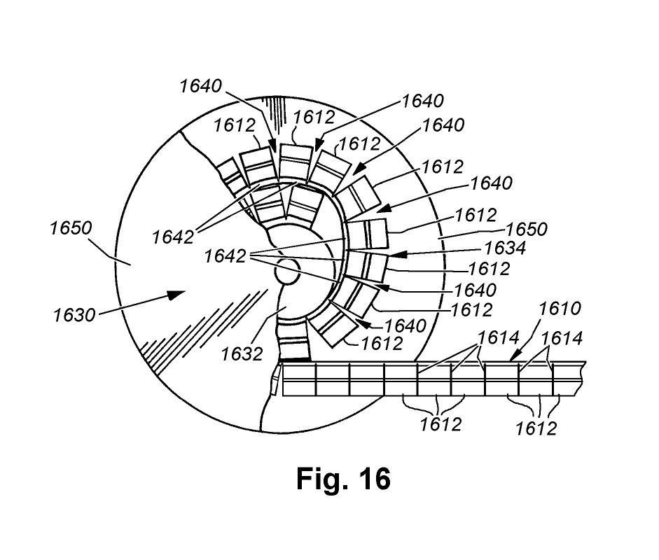

As described above, the clips of this embodiment can be formed as a strip with cut lines at predetermined spacings. These cut lines nearly sever the clips, but remain joined along a portion of the interconnected bases. The partial cut in each base affords a degree of flexibility between clip segments—and the clips are capable of rotating about the cut lines within a predetermined range of motion. As shown in FIG. 16, the strip 1610 with clip segments 1612, and adjoining cut lines 1614, can be rolled onto a spool 1630, having a core 1632 of predetermined diameter (depending upon clip size). The strip 1610 is shown partially paid out of the spool 1630. The wound part 1634 is show with the clip segments 1612 forming open wedge-shaped separations 1640, as the bases 1642 bend about the remaining joined material at the cut lines. In other words, the small remaining joint in each base allows the strips to open-up, so as to be easily rolled onto the spool. The technique by which the strip 1610 is wound onto the spool is highly variable. In the depicted example, the strip is wound in a single stack separated by closely spaced side plates 1650. In alternate embodiments, the clip strip can be wound onto a wide spool in a commonly used traversing manner so that the wind exhibits a wind pattern that is both radially stacked and (axially) side-by-side.

It should be clear that the above embodiment provide a clip that is sturdy, easy to deploy, versatile and formed by a number of readily available mass-production processes. The clip can be provided in a manner that facilitates automation of installation in a number of industries.

The foregoing has been a detailed description of illustrative embodiments of the invention. Various modifications and additions can be made without departing from the spirit and scope if this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. For example, The inner surface of the jaws can be provided with a resilient layer that improves frictional grip on the gripped member and allows for variation in the size of the member relative to a specific size of clip (since the layer compresses more to conform to slightly larger-diameter members). In addition, the thin interconnection between the base plates on separated clips in a strip can be provided with through-cut perforations along the adjoining base plates to facilitate easier separation by hand or machine. Also, the clip can be enlarged and adapted to secure large items, such as sewer pipes. Anchor bases for such clips (and others) can be adapted to secure into earth, gravel or concrete. Other bases can allow the clip to be employed as part of a modular system, including rack systems, structured wiring panels and tool holders. Where the clip is used for holding tools and other items that may require repeated open/close cycles, appropriate frictional surfaces can be applied to the jaws where needed, and the jaws can be provided with tabs that facilitate the opening and release of the jaws. Also, while a roll of clips that are nearly separated except of a line of material at the base are shown, the material joining the clip segments can be located at another position, such as the jaw ends (with bases fully separated). Alternatively, the clip strip may be stored on a roll and/or paid out to a utilization device in an unseparated form where the strip is sufficiently flexible and/or the wind on the roll is sufficient large in radius. The utilization device would then slice off each clip from the strip to an appropriate length (possibly a variable length). Accordingly, this description is meant to be taken only by way of example, and not to otherwise limit the scope of this invention.

What is claimed is:

1. A clip for joining a tubular member comprising:
a first jaw and a second jaw, each joined together by a center living hinge, the first jaw and the second jaw each having a gripping surface and a surface opposite the gripping surface;
a base spring having a first cantilevered end attached to the surface opposite the gripping surface of the first jaw by a first side living hinge and a second cantilevered end attached to the surface opposite the gripping surface of the second jaw by a second side living hinge, wherein the first jaw rotates about the first side hinge and the second jaw rotates about the second side hinge in response to force applied to the center hinge toward the base spring so as to move the first jaw and the second jaw from a fully open orientation in which the first jaw and the second jaw are positioned to receive the tubular member to a fully closed orientation in which the gripping surface of each of first jaw and the second jaw conforms approximately to an outer dimension of the tubular member; and
a base, joined to the base spring adapted to be mounted to a predetermined structure.

2. The clip as set forth in claim 1 wherein the base is constructed and arranged to adhere to a foam substrate.

3. The clip as set forth in claim 1 wherein the base includes an adhesive material adapted to attach to a surface.

4. The clip as set forth in claim 1 wherein the base includes structures that receive fasteners that pass through the base and into a surface.

5. The clip as set forth in claim 1 wherein the gripping surface of the first jaw and the second jaw each includes a high-friction coating.

6. The clip as set forth in claim 1 wherein the surface opposite the gripping surface of the first jaw and the second jaw each includes a first locking formation and a confronting surface of the base spring includes second locking formations each constructed and arranged to engage each of the first locking formations, respectively when the first jaw and the second jaw are moved into a fully closed orientation.

7. The clip as set forth in claim 1 wherein the first jaw includes a first locking formation at a first jaw end and the second jaw includes a second locking formation at the second jaw and wherein the first jaw end and the second jaw end are constructed and arranged to contact each other when the first jaw and the second jaw are moved into the fully closed orientation.

8. The clip as set forth in claim 1 wherein the clip for joining tubular members is attached to a strip of segments each comprising the clip for joining tubular members of claim 1.

9. The clip as set forth in claim 8 wherein each of the segments includes a segment base and wherein the segments are separated from each other except for a line of material on each segment base so that the segments bend with respect to each other at the line of material.

10. The clip as set forth in claim 9 wherein the strip of segments is mounted on a spool.

10. The clip as set forth in claim 8 wherein the strip comprises an extruded strip.

11. The clip as set forth in claim 10 wherein the strip is constructed from a first material and the strip includes portions comprising a second coextruded material that is dissimilar from the first material.

12. The clip as set forth in claim 11 wherein the second material is more resilient than the first material and the second material adapted for use in at least one of the center living hinge, the first side living hinge and the second side living hinge.

13. A method for handling a clip for joining tubular members comprising the steps of:
providing a strip of segments each defining (a) a first jaw and a second jaw, each joined together by a center living hinge, the first jaw and the second jaw each having a gripping surface and a surface opposite the gripping surface, (b) a base spring having a first cantilevered end attached to the surface opposite the gripping surface of the first jaw by a first side living hinge and a second cantilevered end attached to the surface opposite the gripping surface of the second jaw by a second side living hinge, wherein the first jaw rotates about the first side hinge and the second jaw rotates about the second side hinge in response to force applied to the center hinge toward the base spring so as to move the first jaw and the second jaw from a fully open orientation in which the first jaw and the second jaw are positioned to receive the tubular member to a fully closed orientation in which the gripping surface of each of first jaw and the second jaw conforms approximately to an outer dimension of the tubular member, and (c) a base, joined to the base spring adapted to be mounted to a predetermined structure; and
feeding an end of the strip to a clip utilization device that separates a segment from the end and deposits the segment at a predetermined location.

14. The method as set forth in claim 13 wherein each base of each segment is joined together by a line of material and each segment is otherwise separated.

15. The method as set forth in claim 14 wherein the strip is mounted on a spool for payout to the utilization device.

16. The method as set forth in claim 13 wherein the step of feeding includes depositing the segment in a mold cavity so that the base becomes embedded in foam applied to the mold cavity.

17. A system for storing a clip for joining tubular members comprising:
a strip of segments each defining (a) a first jaw and a second jaw, each joined together by a center living hinge, the first jaw and the second jaw each having a gripping surface and a surface opposite the gripping surface, (b) a base spring having a first cantilevered end attached to the surface opposite the gripping surface of the first jaw by a first side living hinge and a second cantilevered end attached to the surface opposite the gripping surface of the second jaw by a second side living hinge, wherein the first jaw rotates about the first side hinge and the second jaw rotates about the second side hinge in response to force applied to the center hinge toward the base spring so as to move the first jaw and the second jaw from a fully open orientation in which the first jaw and the second jaw are positioned to receive the tubular member to a fully closed orientation in which the gripping surface of each of first jaw and the second jaw conforms approximately to an outer dimension of the tubular member, and (c) a base, joined to the base spring adapted to be mounted to a predetermined structure; and
a spool onto which the strip of segments are wound for payout of an end of the strip, the segments being constructed and arranged to be separated from the strip by a downstream process.

18. The system as set forth in claim 17 wherein each base of each segment is joined together by a line of material and each segment is otherwise separated.
